(19) United States
(12) Patent Application Publication
(10) Pub. No.: US 2011/0176866 A1
(43) Pub. Date: Jul. 21, 2011

(54) Bible stand connection

(76) Inventors: Ronald A. Miserendino, West Allis, WI (US); Scott Brammer, Fredonia, WI (US)

(21) Appl. No.: 12/657,335

(22) Filed: Jan. 19, 2010

(51) Int. Cl. F16B 12/12

(52) U.S. Cl. 403/361

(57) ABSTRACT

A wooden connection absent of metal fasteners or tools to assemble or disassemble. Parts are pressed together by hand with normal pressure. To disassemble merely pull apart with normal pressure. Continuous assembly and disassembly is assured with this connection design.

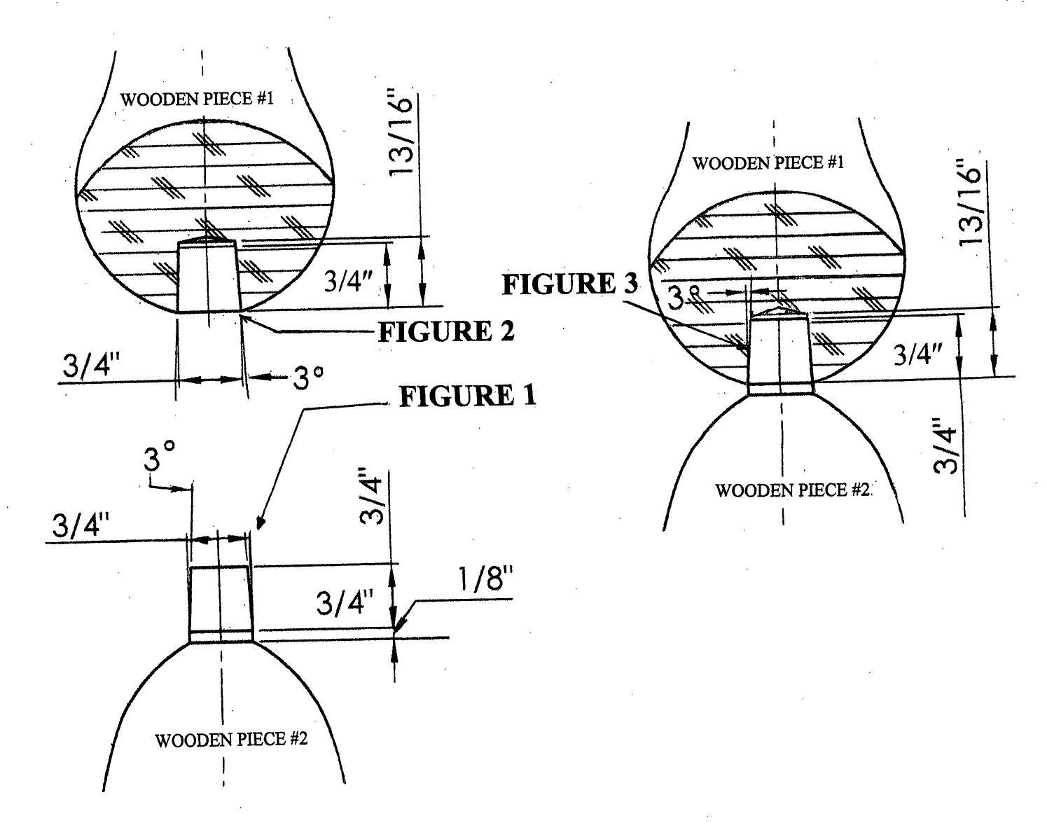

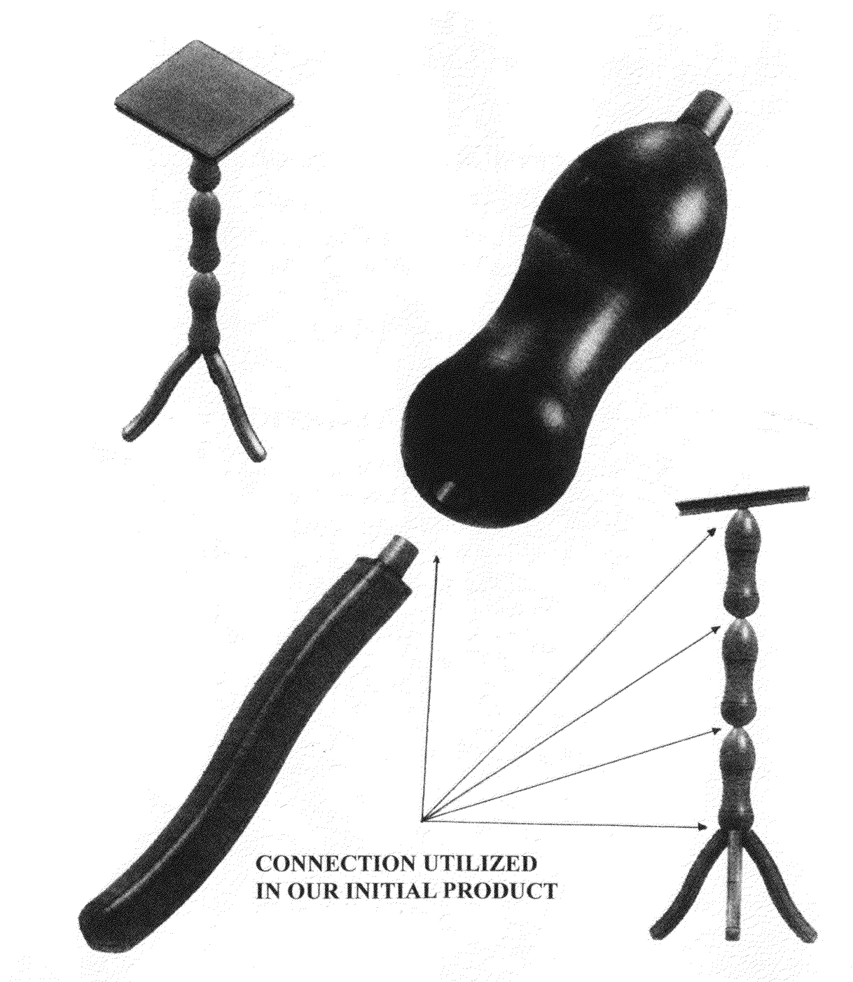

The lathe turned wood connection design allows the repetitive assembly and disassembly of two pieces of wood. The lathe turned male connection (SEE FIG. 1) is designed with a degree of taper corresponding to a matching tapered female connection hole (SEE FIG. 2). This degree of taper gives the connection (SEE FIG. 3) repeated assembly and disassembly capability with out the use of tools.

On page 1 of 2 of drawing submitted:

The drawings on left are samples, of disconnected, pieces of wood.

FIG. 1—The drawing on lower left of page, shows a piece of wood with a sample tapered stud of 3°.

FIG. 2—The drawing on top left of page, shows a piece of wood with a sample tapered hole of 3°.

FIG. 3—The drawing on the right side of page, shows these same pieces of wood connected together, utilizing the 3° stud of FIG. 1 (lower view) with the matching 3° hole of FIG. 2 (upper view).

On page 2 of 2 of drawings submitted:

The center illustration shows disconnected samples of the 3° tapered stud and matching 3° tapered hole.

The right illustration arrows point to where the sample connection is used with a male stud and matching female hole.

1. Tapered Connections of 3° (INDICATED on drawing, THE OPTIMUM) (SEE FIGS. 1 AND 2) is the uniqueness and key to our tool less assembly. Our studies have shown that a taper ranging 1 ½° to a maximum of 4 ½° on both the wooden, lathe turned male end (SEE FIG. 1) and the matching taper drilled, wooden female hole (SEE FIG. 2) will provide exceptional stability when hand assembled (SEE FIG. 3).

2. Our claim is the tapered degree range of 1 ½° to 4 ½° allowing the stand its repeated hand assembly (FIG. 3) and disassembly without the use of tools.
